(19) United States
(12) Patent Application Publication
(10) Pub. No.: US 2010/0125805 A1
(43) Pub. Date: May 20, 2010

(54) METHODS OF PROVIDING USER INTERFACE FOR CONTROL OF DIGITAL IMAGING SYSTEM AND CORRESPONDING APPARATUS

(75) Inventor: Ralph H. STOOS, JR., Ontario, NY (US)

Correspondence Address: Prass LLP, 2661 Riva Road, Building 1000, Suite 1044, Annapolis, MD, 21401, US

(73) Assignee: XEROX CORPORATION, Norwalk, CT (US)

(21) Appl. No.: 12/273,821

(22) Filed: Nov. 19, 2008

(51) Int. Cl. G06F 3/048

(52) U.S. Cl. 715/769

(57) ABSTRACT

Disclosed are methods of providing a user interface to control operation of a digital imaging system, and corresponding apparatus and computer readable medium. The methods include displaying to a user on a display of the digital imaging system the user interface having a plurality of user interface display areas, the plurality of user interface display areas including a job list for displaying at least one available job, a job workspace for displaying a selected job be worked on, and a plurality of job modification display areas, each of the job modification display areas including at least one job modification feature, receiving from a user an indication of the selected job of the at least one available job to be worked on, wherein the user indicates selection of the selected job to be worked on by dragging and dropping one of the at least one available job to be worked on from the job list to the job workspace, displaying the selected job in the job workspace, receiving from the user at least one job modification of the selected job, wherein the user indicates selection of the at least one job modification by dragging and dropping the at least one job modification from at least one of the plurality of job modification display areas to the selected job in the job workspace, and displaying the at least one job modification with the selected job in the job workspace.

### BACKGROUND

Disclosed herein are methods of providing a user interface to control operation of a digital imaging system, as well as corresponding apparatus.

Image forming devices such as printers, copiers and multi-function devices provide users the ability to print from a device such as a desktop or laptop computer, a handheld computer, or other electronic devices, to a printer connected to the device. The electronic devices may be stand alone devices, or may be connected in a network, such as in a business computing environment, which may include one or more printers.

More complex production printing systems, such as digital presses and the like, often include a digital front end providing software and user interfaces to control complex printing jobs. These user interfaces may be very complex and cumbersome for a user to utilize

### SUMMARY

According to aspects of the embodiments, there is provided methods of providing a user interface to control operation of a digital imaging system, and corresponding apparatus and computer readable medium. The methods include displaying to a user on a display of the digital imaging system the user interface having a plurality of user interface display areas, the plurality of user interface display areas including a job list for displaying at least one available job, a job workspace for displaying a selected job be worked on, and a plurality of job modification display areas, each of the job modification display areas including at least one job modification feature, receiving from a user an indication of the selected job of the at least one available job to be worked on, wherein the user indicates selection of the selected job to be worked on by dragging and dropping one of the at least one available job to be worked on from the job list to the job workspace, displaying the selected job in the job workspace, receiving from the user at least one job modification of the selected job, wherein the user indicates selection of the at least one job modification by dragging and dropping the at least one job modification from at least one of the plurality of job modification display areas to the selected job in the job workspace, and displaying the at least one job modification with the selected job in the job workspace.

### BRIEF DESCRIPTION OF THE DRAWINGS

FIG. 1 illustrates a block diagram of a system for controlling a printer.

FIG. 2 illustrates a block diagram of a system for controlling a printer.

FIG. 3 illustrates a diagram of a user interface.

FIG. 4 illustrates a diagram of a user interface.

FIG. 5 illustrates a diagram of a user interface.

FIG. 6 illustrates a diagram of a user interface.

FIG. 7 illustrates a diagram of a user interface.

FIG. 8 illustrates a diagram of a user interface.

FIG. 9 illustrates a flowchart of a method of providing a user interface to control operation of a digital imaging system.

### DETAILED DESCRIPTION

Aspects of the embodiments disclosed herein relate to methods of providing a user interface to control operation of a digital imaging system, and corresponding apparatus and computer-readable medium. The embodiments may include a simple digital imaging system such as may be used on a personal computer, a complex digital imaging system such as a digital press, or anything in between.

The embodiments include methods of providing a user interface to control operation of a digital imaging system. The methods include displaying to a user on a display of the digital imaging system the user interface having a plurality of user interface display areas, the plurality of user interface display areas including a job list for displaying at least one available job, a job workspace for displaying at least one selected job be worked on, and a plurality of job modification display areas, each of the job modification display areas including at least one job modification feature, receiving from a user an indication of the at least one selected job of the at least one available job to be worked on, wherein the user indicates selection of the at least one selected job to be worked on by dragging and dropping one of the at least one available job to be worked on from the job list to the job workspace, displaying the selected job in the job workspace, receiving from the user at least one job modification of the selected job, wherein the user indicates selection of the at least one job modification by dragging and dropping the at least one job modification from at least one of the plurality of job modification display areas to the selected job in the job workspace, and displaying the at least one job modification with the selected job in the job workspace.

The embodiments further include an apparatus for controlling operation of a digital imaging system. The apparatus includes a memory that stores instructions, a display for displaying a user interface to a user, a user input device for allowing the user to interface with the digital imaging system, and a processor that executes the instructions to cause display and manipulation of the user interface of the digital imaging system upon receipt input from the user on the user input device, wherein the processor causes: display of the user interface having a plurality of user interface display areas, the plurality of user interface display areas including a job list for displaying at least one available job, a job workspace for displaying at least one selected job be worked on, and a plurality of job modification display areas, each of the job modification display areas including at least one job modification feature, displaying the selected job in the job workspace in response to receiving from a user an indication of the at least one selected job of the at least one available job to be worked on, wherein the user indicates selection of the at least one selected job to be worked on by dragging and dropping on the user input device one of the at least one available job to be worked on from the job list to the job workspace, and displaying the at least one job modification with the selected job in the job workspace in response to receiving from the user at least one job modification of the selected job, wherein the user indicates selection of the at least one job modification by dragging and dropping on the user input device the at least one job modification from at least one of the plurality of job modification display areas to the selected job in the job workspace.

The embodiments further include a computer readable medium, having a computer-usable data carrier storing instructions, the instructions when executed by a computer causing the computer to provide a user interface to control a digital imaging system by: displaying to a user on a display of the digital imaging system the user interface having a plurality of user interface display areas, the plurality of user interface display areas including a job list for displaying at least one available job, a job workspace for displaying at least one selected job be worked on, and a plurality of job modification display areas, each of the job modification display areas including at least one job modification feature, receiving from a user an indication of the at least one selected job of the at least one available job to be worked on, wherein the user indicates selection of the at least one selected job to be worked on by dragging and dropping one of the at least one available job to be worked on from the job list to the job workspace, displaying the selected job in the job workspace, receiving from the user at least one job modification of the selected job, wherein the user indicates selection of the at least one job modification by dragging and dropping the at least one job modification from at least one of the plurality of job modification display areas to the selected job in the job workspace, and displaying the at least one job modification with the selected job in the job workspace.

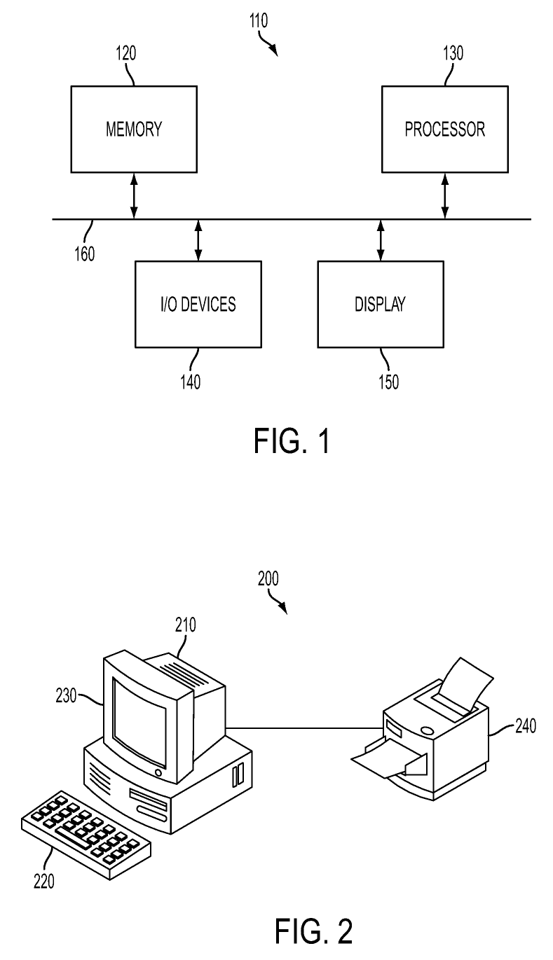

FIG. 1 illustrates a diagram of a system 110. The system 110 may be embodied within devices such as a digital imaging system, a desktop computer, a laptop computer, a handheld computer, a handheld communication device, or another type of computing device, or the like. The system 110 may include a memory 120, a processor 130, input/output devices 140, a display 150 and a bus 160. The bus 160 may permit communication and transfer of signals among the components of the computing device 110.

Processor 130 may include at least one conventional processor or microprocessor that interprets and executes instructions. The processor 130 may be a general purpose processor or a special purpose integrated circuit, such as an ASIC, and may include more than one processor section. Additionally, the system 110 may include a plurality of processors 130.

Memory 120 may be a random access memory (RAM or another type of dynamic storage device that stores information and instructions for execution by processor 130. Memory 120 may also include a read-only memory (ROM which may include a conventional ROM device or another type of static storage device that stores static information and instructions for processor 130. The memory 120 may be any memory device that stores data for use by system 110.

Input/output devices 140 (I/O devices) may include one or more conventional input mechanisms that permit a user to input information to the system 110, such as a microphone, touchpad, keypad, keyboard, mouse, pen, stylus, voice recognition device, buttons, etc., and output mechanisms such as one or more conventional mechanisms that output information to the user, including a display, one or more speakers, a storage medium, such as a memory, magnetic or optical disk, disk drive, a printer device, etc., and/or interfaces for the above. The display 150 may typically be an LCD or CRT display as used on many conventional computing devices, or any other type of display device.

The system 110 may perform functions in response to processor 130 by executing sequences of instructions or instruction sets contained in a computer-readable medium, such as, for example, memory 120. Such instructions may be read into memory 120 from another computer-readable medium, such as a storage device, or from a separate device via a communication interface, or may be downloaded from an external source such as the Internet. The system 100 may be a stand-alone system, such as a personal computer, or may be connected to a network such as an intranet, the Internet, or the like.

The memory 120 may store instructions that may be executed by the processor to perform various functions. For example, the memory may store printer driver instructions to allow the system to perform various printing functions in association with a particular printer connected to the system. The printer driver instructions are typically unique to each specific type of printer, and the system 110 may store a plurality of print drivers each for a different printer.

FIG. 2 illustrates a system 200. The system 200 includes a computer 210, which includes the elements of system 110, including the memory 120, the processor 130, l/O devices 140 and a display 150. The computer 210 could be a standard personal computer, or could be another type of computing device such as a digital imaging system, a handheld computer, a phone, a laptop computer, or the like.

The system 200 may also include a keyboard 220 functioning as an input device. The keyboard may be replaced or supplemented by the input devices as illustrated in FIG. 1.

The system 200 may also include a display 230 functioning as an output device for displaying images generated or received by the computer 210, corresponding to display 150 shown in FIG. 1. The display 230 may display images to be viewed by a user, such as various application programs, a user interface (UI), text, photographic images, or the like. For example, the display may generate a user interface in response to instructions stored in memory 120, such as a user interface for a digital imaging system.

The system 200 may have a printer 240 connected thereto for printing data such as images, text, or the like in response to a user directing the computer 210 to print, for example. In response to such a print command, the processor will typically cause the print driver to communicate with the printer to perform the needed printing. The printer 240 may be a small printer, or may be a large printer such as used in a digital production system such as a digital press, or the like. The computer 210 may be an integral part of a printing device, such as a digital production system, and may include a digital front end including software providing user interfaces and the like for assisting a user in operating the system.

The system 200 may be connected to a network, such as such as an intranet, the Internet, a wireless network, or the like. In addition, the system 200 may be connected to a plurality of printers such as printer 240. The plurality of printers may be of a same printer type or of varying printer types. Further, the system 200 and the printer 240 may be integrated into one unit.

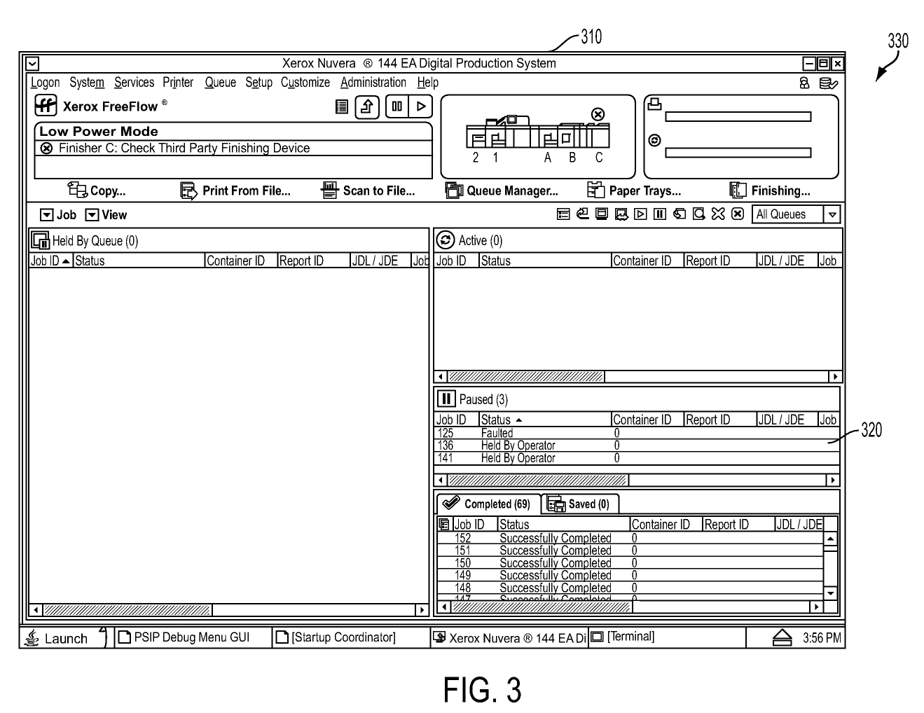

FIG. 3 illustrates a user interface 310 that may be displayed on a display of computer 210. The user interface 310 may be invoked and displayed when a user selects a print function or the like on the computer 210, typically using an input device such as keyboard 220, for example. The user interface 310 may include various display areas, such as a job display area 320 for displaying jobs. The job display area 320 may display one or more jobs that the user can act on.

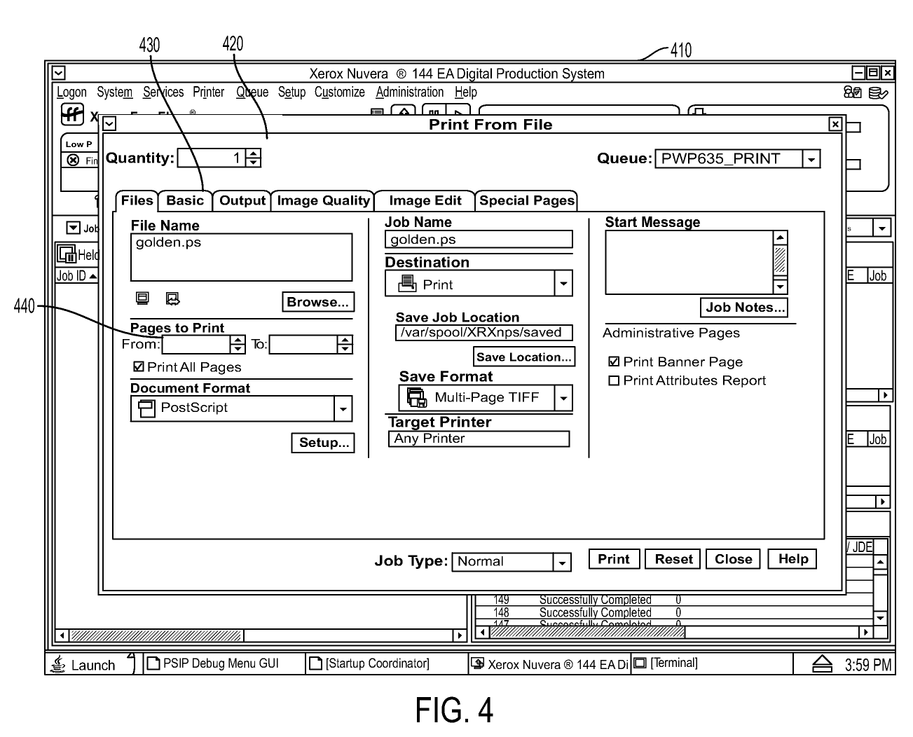

FIG. 4 illustrates an exemplary diagram of a further printer user interface 420 that may be displayed on the display 230 of computer 210, for example. The user may select one of the print jobs from the job display area 320 of user interface 310 (which is the same as user interface 410), and select a function such as print from file, causing the opening of the print from file user interface 420.

The print from file user interface 420 may include various functional tab headers 430 and drop lists, each of which may allow various manipulation of the image to be printed. In the embodiment shown in FIG. 4, the functional tab headers 430 may include Files, Basic, Image Quality, Image Edit, and Special Pages. The print from file user interface 420 may include a Pages to Print input 440, where a user can select pages to print, as well as various other items a user can select or manipulate, such as Document Format, Destination, Target Printer, Start Message, and the like.

Selection of any of the functional headers 430 may cause one or more additional user interfaces to open, which may have additional items for a user to select from. Use of this interface may be complex for a user.

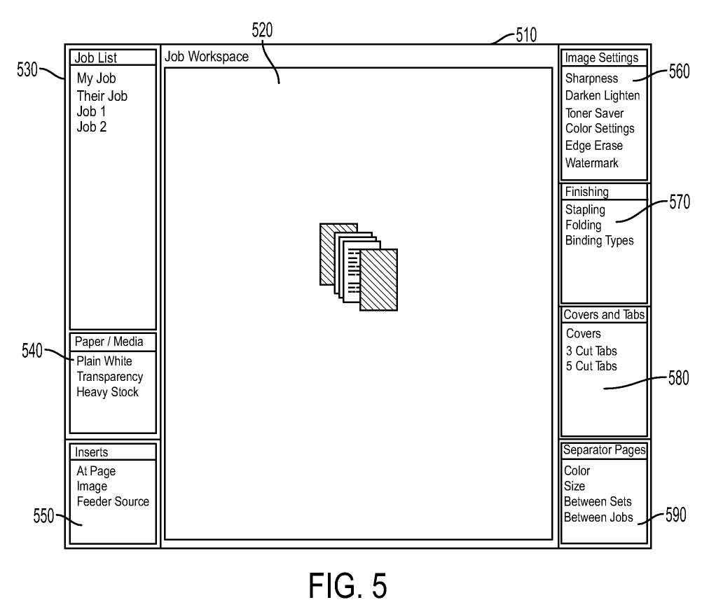

FIG. 5 illustrates a user interface 510 that may be displayed on a display of computer 210. The user interface 510 may include a job workspace 520 where jobs may be listed and worked on, and a job list 530. The user interface 510 may also include various job modification display areas 540, 550, 560, 570, 580 and 590. The job modification display areas display various modifications that a user can make to a job.

The job modification display area 540 is for paper/media, and in this embodiment allows a user to select plain white, transparency, or heavy stock. The job modification display area 550 is for inserts and allows a user to select at page, image or feeder source. The job modification display area 560 is for image settings and allows a user to select sharpness, darken, lighten, toner saver, color settings, edge erase, or watermark. The job modification display area 570 is for finishing and allows a user to select stapling, folding or binding types. The job modification display area 580 is for covers and tabs and allows a user to select covers, 3 cut tabs or 5 cut tabs. The job modification display area 590 is for separator tabs, and allows a user to select color, size, between sets and between jobs. The particular job modification display areas shown are possible examples that may be used, and any other job modifications could be used as well.

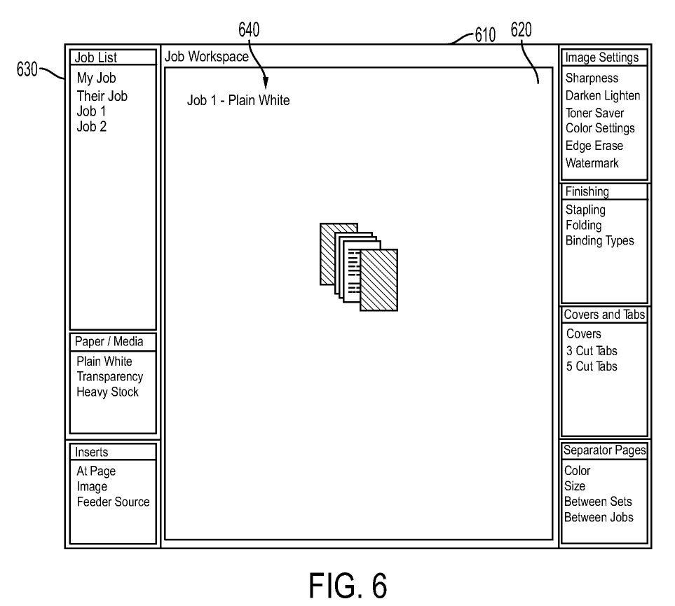

FIG. 6 illustrates a user interface 610 that may be displayed on a display of computer 210. The user interface 610 is identical to the user interface 510, except a job 1 and a job modification 640, in this case plain white paper, have been added to the job workspace 620. A user selected job 1 from the job list 630 and dragged and dropped it into the job workspace 620. Jobs and job modifications can be selected by the user and dragged and dropped into the user workspace using an input device such as a mouse or the like.

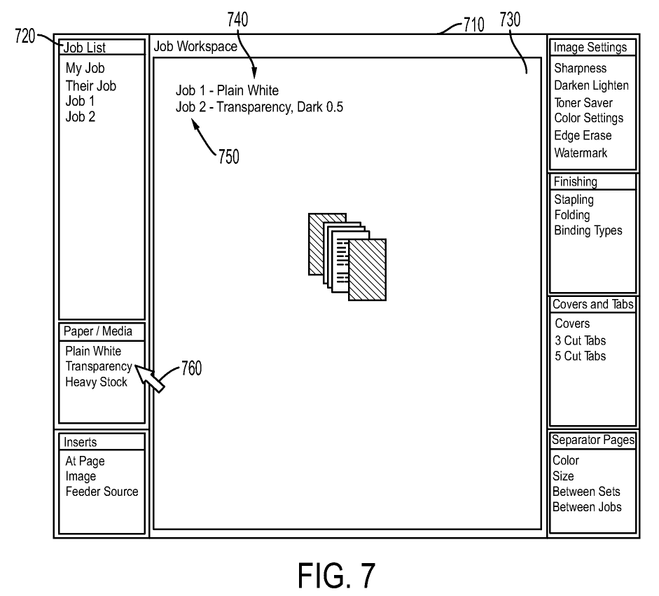

FIG. 7 illustrates a user interface 710 that may be displayed on a display of computer 210. In FIG. 7, two jobs, Job 1 740 and Job 2 750, have been selected by a user and dragged and dropped into the job workspace 712. For job 1, the user has also selected job modifications plain white and staple UL (upper left). For job 2 750, the user has selected transparency and darken 0.5. The transparency job modification is show selected with cursor 760. The user may select any number of jobs to work on in the job workspace 730, and may select as many job modifications as needed for each job using the various job modification display areas by simply selecting a particular job modification such as through the use of a cursor and dragging and dropping the selected job modification onto the job in the job workspace 730.

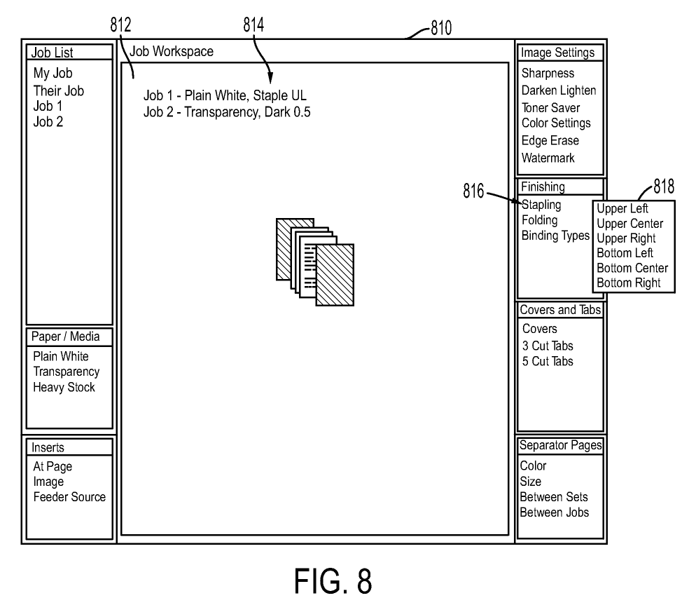

FIG. 8 illustrates a user interface 810 that may be displayed on a display of computer 210. In FIG. 8, two jobs, Job 1 and Job 2, have again been selected by a user and dragged and dropped into the job workspace 812. For job 1, the user has also selected job modifications plain white and staple UL (upper left), job modification 814. In this instance, job modification 814 includes job modification feature staple and job modification sub-feature UL (upper left).

Where a job modification sub-feature is included, it may be selected by a user when selecting a corresponding job modification feature. For example, the job modification feature stapling 816 may when selected by a user cause the job modification sub-features 818 to appear for selection by the user. Any convenient way of displaying the job modification sub-features may be employed, such as the use of a dropdown list or the like. The user may then simply place the cursor over one of the job modification sub-features to select it and drag and drop it onto one of the jobs in the job workspace 812.

The job modification features displayed in the job modification display areas may either have no job modification sub-features or have one or more job modification sub-features as needed. A user may also be able to select one or more job modification sub-features for each job modification feature.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

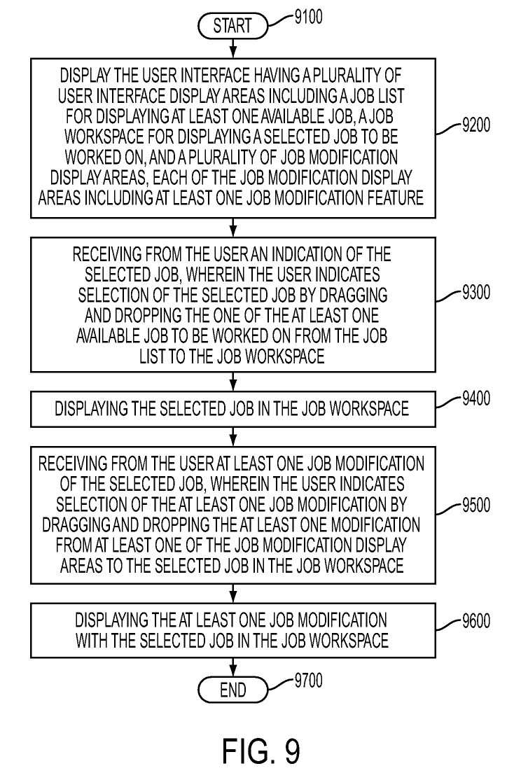

FIG. 9 illustrates a flowchart of a method of providing a user interface to control operation of a digital imaging system. The method starts at 9100. At 9200, the method displays to a user on a display of the digital imaging system the user interface having a plurality of user interface display areas, the plurality of user interface display areas including a job list for displaying at least one available job, a job workspace for displaying at least one selected job be worked on, and a plurality of job modification display areas, each of the job modification display areas including at least one job modification feature

At 9300, the method receives from a user an indication of the at least one selected job of the at least one available job to be worked on, wherein the user indicates selection of the at least one selected job to be worked on by dragging and dropping one of the at least one available job to be worked on from the job list to the job workspace At 9400, the method displays the selected job in the job workspace.

At 9500, the method receives from the user at least one job modification of the selected job, wherein the user indicates selection of the at least one job modification by dragging and dropping the at least one job modification from at least one of the plurality of job modification display areas to the selected job in the job workspace. At 9600, the method displays the at least one job modification with the selected job in the job workspace. At 9700, the method ends.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of providing a user interface to control operation of a digital imaging system, comprising:
displaying to a user on a display of the digital imaging system the user interface having a plurality of user interface display areas, the plurality of user interface display areas including a job list for displaying at least one available job, a job workspace for displaying at least one selected job be worked on, and a plurality of job modification display areas, each of the job modification display areas including at least one job modification feature;
receiving from a user an indication of the at least one selected job of the at least one available job to be worked on, wherein the user indicates selection of the at least one selected job to be worked on by dragging and dropping one of the at least one available job to be worked on from the job list to the job workspace;
displaying the selected job in the job workspace;
receiving from the user at least one job modification of the selected job, wherein the user indicates selection of the at least one job modification by dragging and dropping the at least one job modification from at least one of the plurality of job modification display areas to the selected job in the job workspace; and
displaying the at least one job modification with the selected job in the job workspace.

2. The method of claim 1, wherein the at least one available job includes a plurality of available jobs, and the at least one selected job to be worked on includes a plurality of selected jobs to be worked on.

3. The method of claim 2, further comprising:
receiving from the user an indication of the plurality of selected jobs to be worked on, wherein the user indicates selection of each of the plurality of selected jobs by dragging and dropping a corresponding one of the plurality of available jobs from the job list to the job workspace.

4. The method of claim 3, further comprising:
receiving from the user a first job modification of the plurality of job modifications to be applied to a first one of the selected jobs to be worked on, wherein the user indicates selection of the first job modification by dragging and dropping the first job modification from one of the plurality of job modification display areas to the first one of the selected jobs in the job workspace; and
receiving from the user a second job modification of the plurality of job modifications to be applied to a second one of the selected jobs to be worked on, wherein the user indicates selection of the second job modification by dragging and dropping the second job modification from one of the plurality of job modification display areas to the second one of the selected jobs in the job workspace.

5. The method according to claim 4, further comprising displaying the first one of the selected jobs to be worked on with the first job modification in the job workspace and displaying the second one of the selected jobs to be worked on with the second job modification in the job workspace.

6. The method according to claim 1, wherein the job modification display areas each display a plurality of job modification features, and at least one of the plurality of job modification features includes a plurality of job modification sub-features.

7. The method of claim 6, further comprising displaying the job-modification sub-features for selection by the user when the user selects a corresponding one of the job modification features.

8. The method of claim 7, further comprising receiving a selection of at least one of the plurality of job modification sub-features from the user, and displaying the selected job modification sub-feature with the corresponding selected job and the corresponding selected job modification feature in the job workspace.

9. An apparatus for controlling operation of a digital imaging system, comprising:
a memory that stores instructions;
a display for displaying a user interface to a user;
a user input device for allowing the user to interface with the digital imaging system; and
a processor that executes the instructions to cause display and manipulation of the user interface of the digital imaging system upon receipt input from the user fromon the user input device, wherein the processor causes:
display of the user interface having a plurality of user interface display areas, the plurality of user interface display areas including a job list for displaying at least one available job, a job workspace for displaying at least one selected job be worked on, and a plurality of job modification display areas, each of the job modification display areas including at least one job modification feature;
displaying the selected job in the job workspace in response to receiving from a user an indication of the at least one selected job of the at least one available job to be worked on, wherein the user indicates selection of the at least one selected job to be worked on by dragging and dropping on the user input device one of the at least one available job to be worked on from the job list to the job workspace; and
displaying the at least one job modification with the selected job in the job workspace in response to receiving from the user at least one job modification of the selected job, wherein the user indicates selection of the at least one job modification by dragging and dropping on the user input device the at least one job modification from at least one of the plurality of job modification display areas to the selected job in the job workspace.

10. The apparatus of claim 9, wherein the at least one available job includes a plurality of available jobs, and the at least one selected job to be worked on includes a plurality of selected jobs to be worked on.

11. The apparatus of claim 10, wherein the processor receives an indication of the plurality of selected jobs to be worked on, wherein the user indicates selection of each of the plurality of selected jobs by dragging and dropping a corresponding one of the plurality of available jobs from the job list to the job workspace using the user input device.

12. The apparatus of claim 11, wherein the processor further receives a first job modification of the plurality of job modifications to be applied to a first one of the selected jobs to be worked on from the user on the user input device, wherein the user indicates selection of the first job modification by dragging and dropping the first job modification from one of the plurality of job modification display areas to the first one of the selected jobs in the job workspace; and
wherein the processor further receives a second job modification of the plurality of job modifications to be applied to a second one of the selected jobs to be worked on from the user on the user input device, wherein the user indicates selection of the second job modification by dragging and dropping the second job modification from one of the plurality of job modification display areas to the second one of the selected jobs in the job workspace.

13. The apparatus of claim 12, wherein the processor further causes further display of the first one of the selected jobs to be worked on with the first job modification in the job workspace and display of the second one of the selected jobs to be worked on with the second job modification in the job workspace.

14. The apparatus of claim 9, wherein the job modification display areas each display a plurality of job modification features, and at least one of the plurality of job modification features includes a plurality of job modification sub-features.

15. The apparatus of claim 14, wherein the processor further causes display of the job-modification sub-features for selection by the user when the user selects a corresponding one of the job modification features.

16. The apparatus of claim 15, wherein the processor further causes display of the selected job modification sub-feature with the corresponding selected job and the corresponding selected job modification feature in the job workspace in response to receiving a selection of at least one of the plurality of job modification sub-features from the user on the user input device.

17. A computer-readable medium, comprising:
a computer-usable data carrier storing instructions, the instructions when executed by a computer causing the computer to provide a user interface to control a digital imaging system by:
displaying to a user on a display of the digital imaging system the user interface having a plurality of user interface display areas, the plurality of user interface display areas including a job list for displaying at least one available job, a job workspace for displaying at least one selected job be worked on, and a plurality of job modification display areas, each of the job modification display areas including at least one job modification feature;
receiving from a user an indication of the at least one selected job of the at least one available job to be worked on, wherein the user indicates selection of the at least one selected job to be worked on by dragging and dropping one of the at least one available job to be worked on from the job list to the job workspace;
displaying the selected job in the job workspace;
receiving from the user at least one job modification of the selected job, wherein the user indicates selection of the at least one job modification by dragging and dropping the at least one job modification from at least one of the plurality of job modification display areas to the selected job in the job workspace; and
displaying the at least one job modification with the selected job in the job workspace.

18. The computer-readable medium of claim 17, wherein the at least one available job includes a plurality of available jobs, and the at least one selected job to be worked on includes a plurality of selected jobs to be worked on.

19. The computer-readable medium of claim 18, wherein the instructions further comprise instructions causing the computer to provide a user interface to control a digital imaging system by:
receiving from the user an indication of the plurality of selected jobs to be worked on, wherein the user indicates selection of each of the plurality of selected jobs by dragging and dropping a corresponding one of the plurality of available jobs from the job list to the job workspace.

20. The computer-readable medium of claim 19, wherein the instructions further comprise instructions causing the computer to provide a user interface to control a digital imaging system by:
receiving from the user a first job modification of the plurality of job modifications to be applied to a first one of the selected jobs to be worked on, wherein the user indicates selection of the first job modification by dragging and dropping the first job modification from one of the plurality of job modification display areas to the first one of the selected jobs in the job workspace; and
receiving from the user a second job modification of the plurality of job modifications to be applied to a second one of the selected jobs to be worked on, wherein the user indicates selection of the second job modification by dragging and dropping the second job modification from one of the plurality of job modification display areas to the second one of the selected jobs in the job workspace.
